(19) United States
(12) Patent Application Publication
(10) Pub. No.: US 2009/0325074 A1
(43) Pub. Date: Dec. 31, 2009

(54) LITHIUM ION SECONDARY BATTERY

(75) Inventors: Yusuke Fukumoto, Osaka (JP); Tetsuya Hayashi, Osaka (JP); Kazunori Kubota, Osaka (JP)

Correspondence Address: MCDERMOTT WILL & EMERY LLP, 600 13TH STREET, NW, WASHINGTON, DC, 20005-3096, US

(73) Assignee: Matsushita Electric Industrial Co., Ltd., Osaka (JP)

(21) Appl. No.: 11/917,708

(22) PCT Filed: Jul. 5, 2007
(86) PCT No.: PCT/JP2007/063463

§ 371 Date: Dec. 14, 2007

(30) Foreign Application Priority Data
Jul. 19, 2006 (JP) 2006-196361

(51) Int. Cl. H01M 4/58

(52) U.S. Cl. 429/231.95

(57) ABSTRACT

A lithium ion secondary battery includes a positive electrode, a negative electrode, a porous heat-resistant layer, and a nonaqueous electrolyte. The positive and negative electrodes reversibly absorb and release lithium ions, respectively. The porous heat-resistant layer is provided between the positive electrode and the negative electrode and includes a metal oxide as filler. The nonaqueous electrolyte is impregnated into the porous heat-resistant layer and exists between the positive electrode and the negative electrode. The filler of the porous heat-resistant layer has a particle diameter of 0.1 μm or more and 5.0 μm or less, D10 in particle size distribution measurement of 0.2 μm or more and 0.6 μm or less, and a mode diameter of 0.80 μm or more and 1.25 μm or less.

### TECHNICAL FIELD

The present invention relates to a lithium ion secondary battery. More particularly, the present invention relates to a technique for improving productivity when a porous heat-resistant layer mainly including ceramics particles is formed.

### BACKGROUND ART

In a lithium ion secondary battery, a lithium-containing oxide or the like is used as a positive electrode active material and a carbon material or a silicon (Si) compound is used as a negative electrode active material. Since these active materials have a large capacity density, the battery is widely used as a power supply of any equipment. Recently, while the battery has been required to have a larger capacity, a higher power, and a larger size, there has been a concern about overheating in a case where abnormal short circuit occurs in such a battery due to any accidents.

At present, a microporous film mainly made of resin such as polyolefin is used as a separator for electrically insulating a positive electrode and a negative electrode from each other. Such a microporous film is excellent in ability of retaining a nonaqueous electrolyte but tends to be deformed at a high temperature. Therefore, if an abnormal short circuit occurs in the battery, defect is enlarged around the short circuit portion due to heat generated by the short circuit, which may cause overheating.

In order to prevent such overheating, Patent Document 1 proposes that a porous heat-resistant layer including a magnesium oxide powder be formed on the surface of a negative electrode. This porous heat-resistant layer prevents a positive electrode and a negative electrode from being brought into contact with each other even if a high temperature is generated and the separator melts.

The above-mentioned porous heat-resistant layer is formed by mixing metal oxide such as magnesium oxide as filler, an additive and a solvent so as to form slurry; and applying the slurry on the surface of the subject such as a negative electrode by a coating technique. However, an inorganic oxide powder such as a magnesium oxide powder has a feature of easily aggregating depending upon the shape in general. Therefore, when a porous heat-resistant layer is formed by selecting an inorganic oxide at random and applying it on a negative electrode, and the like, a lump of an aggregated inorganic oxide may be caught by a coating device such as a gravure roll, a nip roll and a die nozzle. Consequently, a streaking phenomenon that a porous heat-resistant layer is not formed only in a portion in which an inorganic oxide lump is caught. Since a porous heat-resistant layer is not present in a portion with a streak, if a highly conductive foreign material is present in this place, the effect of the above-mentioned porous heat-resistant layer is not exhibited. Furthermore, if a large amount of lumps are generated, even if the aggregated inorganic oxide lumps are excluded, the concentration of the slurry as a precursor becomes small. Therefore, it is difficult to obtain a porous heat-resistant layer having a predetermined physical property in that case.

[Patent Document 1] Japanese Patent Unexamined Publication No. 2003-142078

### SUMMARY OF THE INVENTION

The present invention relates to a lithium ion secondary battery having a high-quality porous heat-resistant layer in which the occurrence of streak is eliminated by using filler having an excellent physical property and which can be produced stably while in large quantities. The lithium ion secondary battery of the present invention includes a positive electrode, a negative electrode, a porous heat-resistant layer and a nonaqueous electrolyte. The positive and negative electrodes can reversibly absorb and release lithium ions, respectively. The porous heat-resistant layer is provided between the positive electrode and the negative electrode and includes metal oxide as filler. The nonaqueous electrolyte is impregnated into the porous heat-resistant layer and exists between the positive electrode and the negative electrode. The distribution of the particle diameter of the filler of the porous heat-resistant layer is 0.1 μm or more and 5.0 μm or less. D10 thereof in particle size distribution measurement is 0.2 μm or more and 0.6 μm or less. A mode diameter thereof is 0.80 μm or more and 1.25 μm or less. Since a metal oxide having such physical properties has an extremely low aggregating property, when the metal oxide is used as filler, excellent porous heat-resistant layers having a predetermined thickness and being free from streak can be produced stably. Consequently, it is possible to produce lithium ion secondary batteries having a high heat resistance stably while in large quantities.

### BRIEF DESCRIPTION OF THE DRAWINGS

FIG. 1 is a longitudinal sectional view showing a lithium ion secondary battery in accordance with an exemplary embodiment of the present invention.

FIG. 2 is an enlarged sectional view showing an electrode group of the lithium ion secondary battery shown in FIG. 1.

### DETAILED DESCRIPTION OF THE PREFERRED EMBODIMENTS

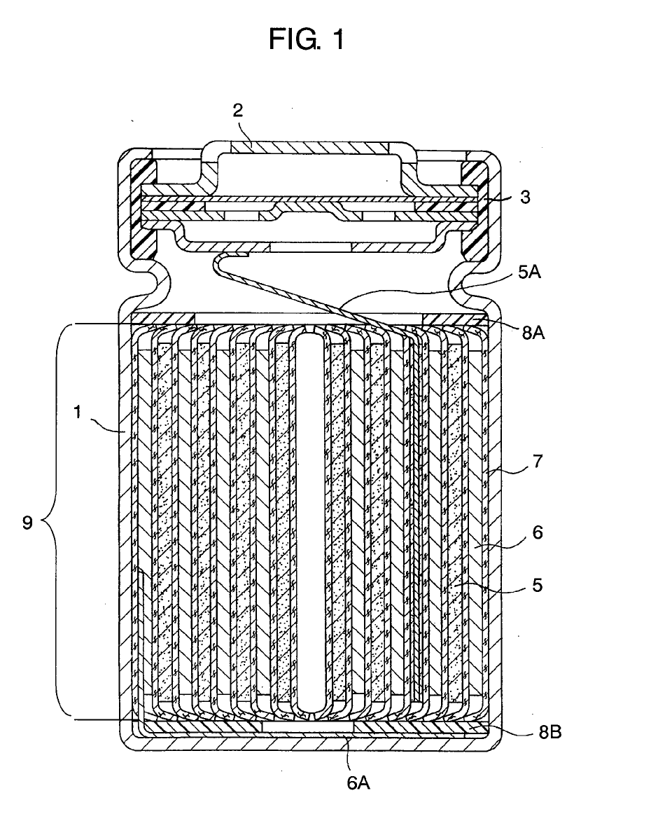

FIG. 1 is a longitudinal sectional view showing a lithium ion secondary battery in accordance with an exemplary embodiment of the present invention. Herein, a cylindrical battery is described as an example. This lithium ion secondary battery includes metallic case 1 and electrode group 9 contained in case 1. Case 1 is made of, for example, stainless steel or nickel-plated iron. Electrode group 9 is formed by winding positive electrode 5 and negative electrode 6 via separator 7 in a spiral shape. Upper insulating plate 8A is disposed in the upper part of electrode group 9 and lower insulating plate 8B is disposed in the lower part of electrode group 9. The open end of case 1 is sealed by caulking case 1 to sealing plate 2 via gasket 3. Furthermore, one end of lead 5A made of aluminum (Al) is attached to positive electrode 5. Another end of lead 5A is coupled to sealing plate 2 that also works as a positive terminal. One end of lead 6A made of nickel (Ni) is attached to negative electrode 6. Another end of lead 6A is coupled to case 1 that also works as a negative terminal. Electrode group 9 is impregnated with a nonaqueous electrolyte (not shown). That is to say, the nonaqueous electrolyte exists between positive electrode 5 and negative electrode 6.

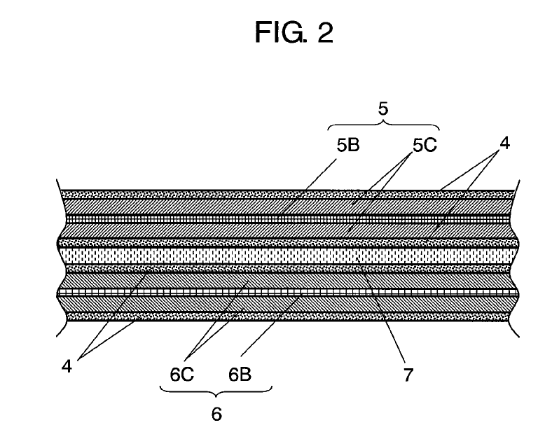

FIG. 2 is an enlarged sectional view showing electrode group 9 of the lithium ion secondary battery shown in FIG. 1. Positive electrode 5 includes current collector 5B and mixture layers 5C formed on both surfaces of current collector 5B. On the other hand, negative electrode 6 includes current collector 6B and mixture layers 6C formed on both surfaces of current collector 6B. Porous heat-resistant layers (hereinafter, referred to as “heat-resistant layers”) 4 are formed on the surfaces of positive electrode 5 and negative electrode 6 facing each other. That is to say, heat-resistant layers 4 are provided between positive electrode 5 and negative electrode 6. Separator 7 is disposed between positive electrode 5 and negative electrode 6. The nonaqueous electrolyte is impregnated into mixture layers 5C and 6C, heat-resistant layers 4 and separator 7.

The form of current collector 5B and mixture layer 5C of positive electrode 5 is not particularly limited. When positive electrode 5 and negative electrode 6 are allowed to face flatly as in, for example, a coin-shaped battery, thin film mixture layer 5C may be supported on one surface of sheet-like current collector 5B. Current collector 5B is made of, for example, aluminum, an aluminum alloy, and the like. Current collector 5B may be subjected to punching, mesh processing, lath processing, surface treatment, and the like. An example of the surface treatment includes plating process, etching treatment, film formation, and the like. The thickness of current collector 5B is, for example, 10 μm to 60 μm.

Mixture layer 5C includes a positive electrode active material. In other words, positive electrode 5 reversibly absorbs and releases lithium ions. As the positive electrode active material, for example, a lithium-containing oxide capable of receiving lithium ions as guests is used. As an example of such lithium-containing oxide, a composite metal oxide of lithium and at least one transition metal selected from the group consisting of cobalt (Co), manganese (Mn), Ni, chromium (Cr), iron (Fe) and vanadium (V) can be used. Above all, a composite metal oxide, in which a part of the transition metal is replaced by Al, magnesium (Mg), zinc (Zn), calcium (Ca), and the like, is desirable.

Among the lithium-containing oxides, it is preferable to use LiₓCoO₂, LiₓMnO₂, LiₓNiO₂, LiₓCrO₂, αLiₓFeO₂, LiₓVO₂, LiₓCo_{y}Ni_{1-y}O₂, LiₓCo_{y}M_{1-y}O_{z}, LiₓNi_{1-y}M_{y}O_{z}, LiₓMn₂O₄, and LiₓMn_{2-y}M_{y}O₄ (herein, M is at least one selected from the group consisting of Na, Mg, Sc, Y, Mn, Fe, Co, Ni, Cu, Zn, Al, Cr, Pb, Sb and B; x=0 to 1.2, y=0 to 0.9, and z=2 to 2.3 are satisfied), transition metal chalcogenide, lithiated vanadium oxide, lithiated niobium oxide, and the like. These materials may be used singly or may be in combination with two or more of them. Note here that the above-mentioned value of x is increased and reduced by charging and discharging. It is preferable that the average particle diameter of the positive electrode active material is in the range from 1 μm to 30 μm.

Mixture layer 5C can include a binder. As the binder to be included in mixture layer 5C, for example, fluorocarbon resin such as polytetrafluoroethylene (PTFE) and polyvinylidene-fluoride (PVdF), rubber particles, and the like can be used. Among them, rubber particles are particularly preferable.

As examples of the rubber particle, a styrene-butadiene rubber (SBR), a denatured product of styrene-butadiene rubber (denatured SBR), and the like can be used. Among them, denatured SBR is particularly preferred.

It is desirable that the denatured SBR includes at least one selected from the group consisting of an acrylonitrile unit, an acrylate unit, an acrylic acid unit, a methacrylate unit and a methacrylic acid unit. It is particularly preferable that the denatured SBR includes an acrylonitrile unit, an acrylate unit and an acrylic acid unit. As the acrylate unit, 2-ethylhexyl acrylate and the like are preferable. When the denatured SBR includes an acrylonitrile unit, an acrylate unit and an acrylic acid unit, it is preferable that in the absorption spectrum obtained in FT-IR measurement, the absorption intensity based on the C═O stretching vibration is 3 to 50 times as the absorption intensity based on the C≡N stretching vibration.

Mixture layer 5C can further include a small amount of conductive agent. As the conductive agent, for example, various carbon blacks can be used.

In a general method for manufacturing positive electrode 5, firstly, a positive electrode mixture paste is prepared. The positive electrode mixture paste is prepared by mixing a positive electrode mixture material with a liquid component (dispersion medium). The positive electrode mixture material includes a positive electrode active material as an essential component and includes a binder, a conductive agent, and the like, as arbitrary components.

The positive electrode mixture paste is coated on one surface or both surfaces of current collector 5B and dried. At this time, current collector 5B is provided with a not-coated portion in which the positive electrode mixture paste is not coated. The not-coated portion is used for welding of lead 5A. The dried positive electrode mixture material supported on current collector 5B is roll-pressed with rollers. Thus, mixture layer 5C whose thickness is controlled is formed.

The configuration of mixture layer 5C is not necessarily limited to the above-mentioned configuration. For example, an active material may be directly accumulated on current collector 5B by a gas phase method.

Next, negative electrode 6 is described. The form of current collector 6B and mixture layer 6C is not particularly limited. That is to say, in the case where positive electrode 5 and negative electrode 6 face each other flatly as in, for example, a coin-shaped battery, thin-film mixture layer 6C may be supported on one surface of sheet-shaped current collector 6B.

Current collector 6B is made of, for example, copper, a copper alloy, and the like. Current collector 6B may be subjected to punching, mesh processing, lath processing, surface treatment, and the like. An example of the surface treatment includes plating processing, etching treatment, film formation, and the like.

Mixture layer 6C includes a negative electrode active material. In other words, negative electrode 6 reversibly absorbs and releases lithium ions at a lower potential than that of positive electrode 5. As the negative electrode active material, for example, a carbon material, an elemental substance of metal, an alloy, a metal compound may be used. An example of the carbon material includes natural graphite, artificial graphite, non-graphitizable carbon, easily-graphitizable carbon, mesophase carbon, and the like. An example of the elemental substance of metal includes silicon, tin, and the like. An example of the alloy includes a silicon alloy (Si—Ti alloy, Si—Cu alloy, and the like). An example of the metal compound includes silicon oxide (SiOₓ(0<x<2)), tin oxide (SnO, SnO₂) and the like. These materials may be used singly or in combination with two or more kinds of materials.

An example of a particularly preferable negative electrode active material includes natural graphite, artificial graphite, non-graphitizable carbon, easily-graphitizable carbon, and the like. It is desirable that these materials have an average particle diameter (median diameter based on volume: D50) of 5 μm to 35 μm. It is further desirable that D50 is 10 μm to 25 μm.

It is preferable that mixture layer 6C includes 0.5 to 5 parts by weight of binder with respect to 100 parts by weight of negative electrode active material. It is further preferable that mixture layer 6C includes 0.8 to 2 parts by weight of binder.

For mixture layer 6C, it is possible to use, for example, the same material as the material of the above-mentioned binder and conductive agent that can be included in mixture layer 5C. Mixture layer 6C can further include 0.5 to 3 parts by weight of thickener with respect to 100 parts by weight of negative electrode active material. As examples of the thickener, carboxymethylcellulose (CMC), methylcellulose, polyvinyl alcohol, polyethylene oxide, polyacrylic acid, and the like can be used. Among them, CMC is particularly preferable.

In a general method for manufacturing negative electrode 6, firstly, a negative electrode mixture paste is prepared. The negative electrode mixture paste is prepared by mixing a negative electrode mixture material with a liquid component (dispersion medium). The negative electrode mixture material includes a negative electrode active material as an essential component and includes a binder, a conductive agent, a thickener, and the like, as arbitrary components.

The negative electrode mixture paste is coated on one surface or both surfaces of current collector 6B and dried. At this time, current collector 6B is provided with a not-coated portion in which the negative electrode mixture paste is not coated. The not-coated portion is used for welding of lead 6A. The dried negative electrode mixture material supported on current collector 6B is roll-pressed with rollers. Thus, mixture layer 6C whose thickness is controlled is formed.

The configuration of mixture layer 6C is not necessarily limited to the above-mentioned configuration. For example, mixture layer 6C may be produced by directly accumulating an active material on current collector 6B by a gas phase method.

As the nonaqueous electrolyte, an aqueous solvent in which lithium salt is dissolved is preferably used. The dissolving amount of lithium salt in the nonaqueous electrolyte is not particularly limited but the concentration of lithium salt is preferably in the range from 0.2 to 2 mol/L and further preferably in the range from 0.5 to 1.5 mol/L.

As examples of the aqueous solvent, cyclic carbonates such as ethylene carbonate (EC), propylene carbonate, butylene carbonate; chain carbonates such as dimethyl carbonate, diethyl carbonate, ethyl methyl carbonate (EMC), dipropyl carbonate; aliphatic carboxylate esters such as methyl formate, methyl acetate, methyl propionate, ethyl propionate; lactons such as γ-butyrolactone and γ-valerolactone; chain ethers such as 1,2-dimethoxyethane, 1,2-diethoxyethane, ethoxymethoxyethane; cyclic ethers such as tetrahydrofuran and 2-methyltetrahydrofuran; dimethyl sulfoxide, 1,3-dioxolane, formamide, acetamide, dimethylformamide, dioxolane, acetonitrile, propylnitrile, nitromethane, ethyl monoglyme, phosphotriester, trimethoxy methane, dioxolane derivative, sulfolane, methyl sulfolane, 1,3-dimethyl-2-imidazolidinone, 3-methyl-2-oxazolidinone, propylene carbonate derivative, tetrahydrofuran derivative, ethyl ether, 1,3-propanesultone, anisole, and N-methyl-2-pyrrolidone. These materials may be used singly, but it is preferable that they may be used in combination with two or more kinds of them. Among them, a mixture solvent of cyclic carbonate and chain carbonate and a mixture solvent of cyclic carbonate, chain carbonate and aliphatic carboxylate ester are preferred.

As the lithium salt to be dissolved in the nonaqueous solvent, for example, LiClO₄, LiBF₄, LiPF₆, LiAlCl₄, LiSbF₆, LiSCN, LiCl, LiCF₃SO₃, LiCF₃CO₂, LiAsF₆, LiN(CF₃SO₂)₂, LiB₁₀Cl₁₀, lower aliphatic lithium carbonate, LiBr, LiI, chloroboran lithium, lithium tetraphenylborate, lithium imide salt, and the like, can be used. These materials may be used singly or used in combination of two or more kinds of them. It is preferable to use at least LiPH₆.

Various additives can be added to the nonaqueous electrolyte for the purpose of improving the charge-discharge property of the battery. As the additives, it is preferable to use, for example, at least one selected from the group consisting of vinylene carbonate, vinyl ethyl carbonate and fluorobenzene. As other various additives, for example, thiethylphosphite, triethanolamine, cyclic ether, ethylenediamine, n-glyme, pyridine, hexaphosphoric acid triamide, nitrobenzene derivative, crown ethers, quaternary ammonium salt, ethylene glycol dialkyl ether, and the like can be used.

As separator 7, a microporous film obtained by applying stretching process to polyolefin such as polyethylene and polypropylene can be used. The preferable thickness ranges is 3 μm or more and 18 μm or less.

Next, heat-resistant layer 4 is described. Heat-resistant layer 4 includes filler. The particle diameter of the filler has a distribution of 0.1 μm or more and 5.0 μm or less, D10 in the particle size distribution measurement of 0.2 μm or more and 0.6 μm or less, and a mode diameter of 0.80 μm or more and 1.25 μm or less.

Heat-resistant layer 4 is prepared as follows. The above-mentioned filler, a binder and a dispersion medium are stirred in a disperser so as to prepare slurry. This slurry is applied to positive electrode 5 and negative electrode 6 and dried. In this way, heat-resistant layer 4 is formed.

Hereinafter, the significance of each parameter of the filler is described. Firstly, by setting a maximum particle diameter to 5.0 μm or less, it is possible to suppress the precipitation of coarse powders mixed when the slurry is prepared. Furthermore, when the minimum particle diameter is too small, particles cannot be dispersed because the cohesive force between particles is extremely large. Therefore, it is preferable that the minimum particle diameter is 0.1 μm or more.

Furthermore, by setting D10 in the particle size distribution measurement to 0.6 μm or less, the slurry is provided with a structural property by the interaction of particles, so that a thickening property is provided. Thus, aggregation can be suppressed. However, when D10 is less than 0.2 μm, the above-mentioned interaction becomes too excessive, resulting in promoting the generation of aggregation. Note here that D10 refers to a particle diameter at 10 volume % in a cumulative graph showing the particle size distribution.

Furthermore, when the mode diameter in the particle size distribution measurement is 0.80 μm or more and 1.25 μm or less, the porosity of formed heat-resistant layer 4 can be made appropriate. Thus, the discharge property of the battery can be improved. When the mode diameter is less than 0.80 μm, the porosity of formed heat-resistant layer 4 becomes excessive. On the contrary, when the mode diameter is more than 1.25 μm, this porosity becomes too small. When the porosity is too excessive, the safety of the battery is deteriorated. When the porosity is too small, the discharge property is deteriorated. Note here that the mode diameter refers to a particle diameter in a part in which the particle frequency is maximum in the particle size distribution.

When all of the above-mentioned parameters are satisfied, with a comprehensively appropriate cohesive force, the slurry as a precursor is provided with a structural viscosity, the precipitation property is suppressed, and a large aggregate lump that may be a direct cause of streaking, and the like, can be prevented from occurring. Herein, since the shape of the metal oxide as the filler is substantially constant (spherical shape, lump shape, and the like), the same values can be obtained as the above-mentioned parameters regardless of whether a wet measuring instrument is used or a dry measuring instrument is used in the particle size distribution measurement.

In addition to this, it is preferable that a specific surface area of the metal oxide as the filler by a BET measuring method is 5 m²/g or more and 12 m²/g or less. By controlling the specific surface area to the above-mentioned preferable range, the above-mentioned effect can be exhibited accurately. Herein, when the specific surface area is less than 5 m²/g, it becomes somewhat difficult to provide the slurry as the precursor with a structural viscosity by an appropriate cohesive force, and thus the precipitation property is slightly increased. On the other hand, when the specific surface area is more than 12 m²/g, a large aggregate lump that is a direct cause of streaking may be somewhat generated.

It is preferable that heat-resistant layer 4 includes 1 to 5 parts by weight of a binder with respect to 100 parts by weight of a metal oxide as filler. It is further preferable that heat-resistant layer 4 includes 2 to 4 parts by weight of the binder. Furthermore, it is particularly preferable that heat-resistant layer 4 includes 2.2 to 4 parts by weight of the binder. When the amount of the binder is less than one part by weight, sufficient strength of heat-resistant layer 4 cannot be obtained occasionally. On the other hand, when the amount of the binder is more than five parts by weight, the discharge property may be deteriorated. However, the preferable amount of the binder varies depending upon the thickness of heat-resistant layer 4. The thinner heat-resistant layer 4 is, the smaller an effect of the amount of a binder on the discharging property becomes.

The binder to be included in heat-resistant layer 4 is not particularly limited. However, it is possible to use, for example, the same resin material as the material of the above-mentioned binder that can be included in mixture layer 5C. Among them, PVdF, rubber particles, and the like, are suitable as the binder to be included in heat-resistant layer 4.

PVdF and rubber particles have an appropriate elasticity. It is desirable that the binder having an appropriate elasticity is present in larger amount in heat-resistant layer 4 rather than in mixture layers 5C and 6C. Since mixture layers 5C and 6C include carbon materials such as graphite and carbon black, they can absorb stress due to roll-pressing. On the other hand, such stress is not applied to heat-resistant layer 4. However, it is preferable that by mixing a larger amount of a binder into heat-resistant layer 4, the resistance of heat-resistant layer 4 with respect to winding is improved. In this way, it is possible to suppress the occurrence of cracks caused by winding in heat-resistant layer 4.

When heat-resistant layer 4 is supported on positive electrode 5 and negative electrode 6, firstly, slurry is prepared as a precursor. The slurry is prepared by mixing metal oxide such as magnesium oxide particles with a liquid component (dispersion medium). For the slurry, a plurality of kinds of metal oxides may be used. Furthermore, in addition to the metal oxide, arbitrary components such as a binder, a thickener and resin filler may be contained. As the liquid component, for example, an organic solvent such as N-methyl-2-pyrrolidone (NMP) and cyclohexanone, or water are used. However, the liquid component is not particularly limited. Note here that it is desirable that a device to be used for mixing the metal oxide and the liquid component, a medialess disperser is used. In particular, since magnesium oxide has a low rigidity, when it is subjected to shearing force, cracking and deformation easily occur. However, according to the medialess disperser, it is possible to suppress the cracking and deformation of the metal oxide.

In FIG. 2, heat-resistant layers 4 are provided on both positive electrode 5 and negative electrode 6. However, heat-resistant layer 4 may be provided only on positive electrode 5 or only on negative electrode 6. Furthermore, when heat-resistant layer 4 is formed by using resin such as aramid together with metal oxide as filler, heat-resistant layer 4 may be formed as an independent film and then disposed on a surface where positive electrode 5 and negative electrode 6 face each other. When heat-resistant layer 4 is independently provided between positive electrode 5 and negative electrode 6, the preferable thickness is in the range from 5 μm to 20 μm. In those ways, heat-resistant layer 4 may be provided between positive electrode 5 and negative electrode 6.

Furthermore, for example, when heat-resistant layer 4 is formed as an independent film, namely when the mechanical strength of heat-resistant layer 4 is sufficient, separator 7 may not be used. However, when heat-resistant layer 4 is produced by applying (coating) technique, the mechanical strength is generally low. Therefore, when a shock such as dropping is applied to a lithium ion secondary battery in which only heat-resistant layer 4 is provided between positive electrode 5 and negative electrode 6, heat-resistant layer 4 may be partially collapsed. On the other hand, when separator 7 is used together, separator 7 alleviates the shock. Accordingly, it is preferable that separator 7 is used together, so as to protect heat-resistant layer 4. In this way, it is preferable that separator 7 made of a microporous film is interposed between positive electrode 5 and negative electrode 6. Note here that when separator 7 is used together, heat-resistant layer 4 may be formed on separator 7.

Furthermore, it is preferable that when separator 7 is used, the thickness of heat-resistant layer 4 is made to be 2 μm or more and 20 μm or less. To secure the battery capacity and high heat resistance by considering the use of separator 7 together, the preferable thickness of heat-resistant layer 4 is in the range from 2 μm to 20 μm. Since this preferable range is substantially the same as a general particle diameter of an aggregate lump that may cause a streaking defect, it is a range in which the effect of the present invention can be exhibited remarkably. When the thickness of heat-resistant layer 4 is less than 2 μm, the heat resistance is somewhat reduced. When the thickness is more than 20 μm, the battery capacity cannot be secured. Alternatively, the volume of electrode group 9 is increased in order to secure the same level of the battery capacity, thus reducing the ease of inserting electrode group 9 into case 1.

Note here that it is preferable to use magnesium oxide as the filler. Since the magnesium oxide has a lower rigidity as compared with the other metal oxides such as aluminum oxide and zirconium oxide, various instruments used for forming the slurry are not abraded. Furthermore, since magnesium ions in the sea water can be used as a raw material, even if man-hour for controlling the particle diameter is added, it can be supplied at lower cost as compared with the other metal oxides.

Next, the present exemplary embodiment is described based on specific examples. The present invention is not necessarily limited to the following examples. For example, the present invention may be applied to a prismatic battery or a coin-shaped battery other than a cylindrical battery.

### Example 1

### (i) Production of Positive Electrode 5

Lithium cobaltate having an average particle diameter of 10 μm as a positive electrode active material, an NMP solution of PVdF as a binder, acetylene black as a conductive agent, and an appropriate amount of NMP as a dispersion medium are stirred in a double arm kneader. Thus, a positive electrode mixture paste is prepared. The mixing ratios of a solid part of PVdf and acetylene black are 4 parts by weight and 3 parts by weight with respect to 100 parts by weight of lithium cobaltate, respectively.

Next, the positive electrode mixture paste is applied to the both surfaces of belt-like current collector 5B made of aluminum foil having a thickness of 15 μm. Then, the applied positive electrode mixture paste is dried and roll-pressed with rollers so as to form mixture layers 5C. At this time, the total thickness of current collector 5B and mixture layers 5C supported on both surfaces of current collector 5B is adjusted to 160 μm. The thus produced positive electrode precursor is cut into a width capable of being inserted into cylindrical case 1 that is 18 mm in diameter and 65 mm in height. Thus, positive electrode 5 is formed. Note here that the active material density of mixture layer 5C is 3.6 g/cm³.

### (ii) Production of Negative Electrode 6

Artificial graphite having an average particle diameter of 20 μm as a negative electrode active material, an emulsion solution of denatured SBR as a binder, CMC as a thickener, and an appropriate amount of water as a dispersion medium are stirred in a double arm kneader, Thus, a negative electrode mixture paste is prepared. The mixing ratios of a solid part of denatured SBR and CMC are both one part by weight with respect to 100 parts by weight of artificial graphite, respectively.

Next, the negative electrode mixture paste is applied to both surfaces of belt-like current collector 6B made of copper foil having a thickness of 10 μm. Then, the applied negative electrode mixture paste is dried and roll-pressed with rollers so as to form mixture layers 6C. At this time, the total thickness of current collector 6B and mixture layers 6C supported on both surfaces of current collector 6B is adjusted to 180 μm. The thus produced negative electrode precursor is cut into a width capable of being inserted into case 1 that is 18 mm in diameter and 650 mm in height. Thus, negative electrode 6 is formed. The active material density of mixture layer 6C is 1.8 g/cm³.

### (iii) Formation of Heat-Resistant Layer 4

First magnesium oxide particles having D50 of 0.32 μm, a mode diameter of 0.30 μm and a maximum particle diameter of 0.72 μm are prepared. Herein, D50 means a particle diameter at 50 volume % in the cumulative graph showing the particle size distribution. On the other hand, second magnesium oxide particle having D50 of 1.05 μm, a mode diameter of 0.91 μm and a maximum particle diameter of 4.52 μm are prepared. Then, the first and second magnesium oxide particles are mixed at the weight ratio of 1:5. When the magnesium oxide particles after mixing are measured by using a laser diffraction particle size analyzer, a maximum particle diameter is resulted in 4.52 μm, D10 resulted in 0.41 μm and the mode diameter resulted in 0.91 μm. To this mixture, 3 parts by weight of a solid part of PVdF as a binder, and an appropriate amount of NMP as a dispersion medium are stirred in a medialess disperser so as to prepare slurry. This slurry is applied to negative electrode 6 so as to cover the surface of mixture layers 6C with the slurry, and then dried. Thus, heat-resistant layers 4 are formed.

Note here that a BET specific surface area of this mixture is 8.8 m²/g when it is measured by a multipoint nitrogen adsorption method. Furthermore, from a weight measured by a fluorescent X-ray analyzer using a calibration curve, it is shown that the thickness of heat-resistant layer 4 is 5.0 μm.

### (iv) Production of Battery

Lead 5A of Al and lead 6A of Ni are attached to the above-mentioned positive electrode 5 and negative electrode 6, respectively. Thereafter, positive electrode 5 and negative electrode 6 are wound via separator 7 that is a polypropylene microporous film having a thickness of 20 μm so as to produce electrode group 9. Upper insulating plate 8A is disposed on the upper surface of electrode group 9. Lower insulating plate 8B is disposed on the lower surface of electrode group 9. Electrode group 9 is inserted into case 1 that is a metallic can with a bottom, which have a diameter of 18 mm and height of 65 mm. Thereafter, a nonaqueous electrolyte is infused into case 1. The nonaqueous electrolyte includes LiPF₆ dissolved at the concentration of 1 mol/L in a mixture solvent including EC and EMC at the weight ratio of 1:3.

After the nonaqueous electrolyte is infused, sealing plate 2 having gasket 3 in the peripheral portion thereof is disposed in the opening portion of case 1 and then case 1 is sealed. Before sealing, sealing plate 2 and lead 5A as well as case 1 and lead 6A are electrically coupled to each other. Thus, a lithium ion secondary battery having a nominal capacity of 2 Ah is completed. This battery is defined as Example 1.

### Example 2

First magnesium oxide particles having D50 of 0.15 μm, a mode diameter of 0.13 μm and a maximum particle diameter of 0.34 μm are prepared and are mixed with the same second magnesium oxide particles as that of Example 1 at the weight ratio of 1:5. Thus, a mixture having a maximum particle diameter of 4.52 μm, D10 of 0.20 μmm, a mode diameter of 0.91 μm and the BET specific surface area of 11.9 m²/g is prepared. A lithium ion secondary battery is produced by the same manner as in Example 1 except for this procedure. This battery is defined as Example 2.

### Example 3

First magnesium oxide particles having D50 of 0.50 μm, a mode diameter of 0.38 μm and a maximum particle diameter of 0.95 μm are prepared, and are mixed with the same second magnesium oxide particles as that of Example 1 at the weight ratio of 1:5. Thus, a mixture having a maximum particle diameter of 4.52 μm, D10 of 0.60 μm, a mode diameter of 0.91 μm and a BET specific surface area of 10.6 m²/g is prepared. A lithium ion secondary battery is produced by the same manner as in Example 1 except for this procedure. This battery is defined as Example 3.

### Comparative Example 1

First magnesium oxide particles having D50 of 0.08 μm, a mode diameter of 0.09 μm and a maximum particle diameter of 0.21 μm are prepared and are mixed with the same second magnesium oxide particle as that of Example 1 at the weight ratio of 1:5. Thus, a mixture having a maximum particle diameter of 4.52 μm, D10 of 0.16 μmm, a mode diameter of 0.91 μm and a BET specific surface area of 32.0 m²/g is prepared. A lithium ion secondary battery is produced by the same manner as in Example 1 except for this procedure. This battery is defined as Comparative Example 1.

### Comparative Example 2

First magnesium oxide particles having D50 of 0.63 μm, a mode diameter of 0.52 μm and a maximum particle diameter of 1.05 μm are prepared, and are mixed with the same second magnesium oxide particle as that of Example 1 at the weight ratio of 1:5. Thus, a mixture having a maximum particle diameter of 4.52 μm, D10 of 0.67 μmm, a mode diameter of 0.91 μm and a BET specific surface area of 9.4 m²/g is prepared. A lithium ion secondary battery is produced by the same manner as in Example 1 except for this procedure. This battery is defined as Comparative Example 2.

### Example 4

First magnesium oxide particles having D50 of 0.44 μm, a mode diameter of 0.32 μm and a maximum particle diameter of 0.75 μm and second magnesium oxide particles having D50 of 0.85 μm, a mode diameter of 0.80 μm and a maximum particle diameter of 4.38 μm are mixed with each other at the weight ratio of 1:5. Thus, a mixture having a maximum particle diameter of 4.38 μm, D10 of 0.40 μmm, a mode diameter of 0.80 μm and a BET specific surface area of 10.8 m²/g is prepared. A lithium ion secondary battery is produced by the same manner as in Example 1 except for this procedure. This battery is defined as Example 4.

### Example 5

The same first magnesium oxide particles as that of Example 4 and second magnesium oxide particles having D50 of 1.20 μm, a mode diameter of 1.25 μm and a maximum particle diameter of 4.75 μm are mixed with each other at the weight ratio of 1:5. Thus, a mixture having a maximum particle diameter of 4.75 μm, D10 of 0.41 μm, a mode diameter of 1.25 μm and a BET specific surface area of 9.9 m²/g is prepared. A lithium ion secondary battery is produced by the same manner as in Example 1 except for this procedure. This battery is defined as Example 5.

### Comparative Example 3

The same first magnesium oxide particles as that of Example 4 and second magnesium oxide particles having D50 of 0.72 μm, a mode diameter of 0.70 μm and a maximum particle diameter of 3.81 μm are mixed with each other at the weight ratio of 1:5. Thus, a mixture having a maximum particle diameter of 3.81 μm, D10 of 0.42 μm, a mode diameter of 0.70 μm and a BET specific surface area of 11.3 m²/g is prepared. A lithium ion secondary battery is produced by the same manner as in Example 1 except for this procedure. This battery is defined as Comparative Example 3.

### Comparative Example 4

The same first magnesium oxide particles as that of Example 4 and second magnesium oxide particles having D50 of 1.31 μm, a mode diameter of 1.28 μm and a maximum particle diameter of 4.98 μm are mixed with each other at the weight ratio of 1:5. Thus, a mixture having a maximum particle diameter of 4.98 μm, D10 of 0.42 μm, a mode diameter of 1.28 μm and a BET specific surface area of 8.5 m²/g is prepared. A lithium ion secondary battery is produced by the same manner as in Example 1 except for this procedure. This battery is defined as Comparative Example 4.

### Example 6

A lithium ion secondary battery is produced by the same manner as in Example 1 except that separator 7 is not used and the thickness of heat-resistant layer 4 is 10 μm. This battery is defined as Example 6.

### Example 7

A lithium ion secondary battery is produced by the same manner as in Example 1 except that the film thickness of heat-resistant layer 4 is 1.0 μm. This battery is defined as Example 7.

### Example 8

A lithium ion secondary battery is produced by the same manner as in Example 1 except that the film thickness of heat-resistant layer 4 is 2.0 μm. This battery is defined as Example 8.

### Example 9

A lithium ion secondary battery is produced by the same manner as in Example 1 except that the film thickness of heat-resistant layer 4 is 20.0 μm. This battery is defined as Example 9.

### Example 10

A lithium ion secondary battery is produced by the same manner as in Example 1 except that the film thickness of heat-resistant layer 4 is 25.0 μm. This battery is defined as Example 10.

### Example 11

A lithium ion secondary battery is produced by the same manner as in Example 1 except that only first magnesium oxide particles having D50 of 0.42 μm, a mode diameter of 1.02 μm, a maximum particle diameter of 5.0 μm and a BET specific surface area of 8.8 m²/g are used and second magnesium oxide particles are not used. This battery is defined as Example 11.

### Comparative Example 5

A lithium ion secondary battery is produced by the same manner as in Example 11 except that only first magnesium oxide particles having D50 of 0.44 μm, a mode diameter of 1.05 μm, a maximum particle diameter of 6.0 μm and a BET specific surface area of 9.5 m²/g are used. This battery is defined as Comparative Example 5. Note here that the minimum particle diameter of the first and second magnesium oxide particles used in Examples 1 to 11 and Comparative Examples 1 to 5 is 0.1 μm or more.

The coating property of the slurry that is a precursor of each heat-resistant layer 4 in each of the above-mentioned examples is evaluated by the following conditions. The results are shown in Table 1.

(NV Change Rate after Still Standing Storage for Seven Days)

A solid portion weight percent (NV) in the slurry right after dispersion and the NV in the slurry after still standing storage for seven days are measured by the below mentioned method. A change rate of the NV is calculated from the measured NVs as one of scales showing the stability of a coating material.

Firstly, a part of the slurry right after dispersion is taken out and its NV is measured as follows. After the weight of the collected slurry is measured, the weight is measured every one minute while heating the slurry at 200° C. so as to evaporate a liquid component. When the weight is not changed, the weight at this time is defined as solid state weight. This weight is divided by the weight of the original slurry so as to calculate NV. After NV right after dispersion is measured, the slurry is taken out in a tube having a height of 10 cm and diameter of 1 cm and it is stood still for seven days. The tube is cut out only in the position 1 cm from the bottom of the tube, the slurry in this portion is collected, and NV after storing is measured.

(Presence or Absence of Streaking)

The surface of negative electrode 6 on which the slurry has been applied is observed to examine whether or not a streak having a width of 1 mm or more is present. The streak means a portion in which heat-resistant layer 4 has not been applied linearly.

The batteries of the above-mentioned examples are evaluated by the following conditions and the results are shown in Table 1.

TABLE 1

| | Filler raw material | | | | | | | MgO particles | | | | | | | | Discharge | |
|---|---|---|---|---|---|---|---|---|---|---|---|---|---|---|---|---|---|
| | First MgO | | | Second MgO | | | | in heat | | | Other | | | Coating | | property | |
| | particles | | | particles | | | | resistant layer | | | conditions | | | property | | capacity | Safety |
| | D50 | *1 | *2 | D50 | *1 | *2 | | *2 | D10 | *1 | | *5 | *6 | *7 | | ratio | *9 |
| | (μm) | (μm) | (μm) | (μm) | (μm) | (μm) | *3 | (μm) | (μm) | (μm) | *4 | (μm) | (m²/g) | (%) | *8 | (%) | (° C.) |
| Ex. 1 | 0.32 | 0.30 | 0.72 | 1.05 | 0.91 | 4.52 | 1:5 | 4.52 | 0.41 | 0.91 | P | 5.0 | 8.8 | 3 | N | 91 | 86 |
| Co. 1 | 0.08 | 0.09 | 0.21 | 1.05 | 0.91 | 4.52 | 1:5 | 4.52 | 0.16 | 0.91 | P | 5.0 | 32.0 | 10 | P | 85 | 90 |
| Ex. 2 | 0.15 | 0.13 | 0.34 | 1.05 | 0.91 | 4.52 | 1:5 | 4.52 | 0.20 | 0.91 | P | 5.0 | 11.9 | 4 | N | 89 | 88 |
| Ex. 3 | 0.50 | 0.38 | 0.95 | 1.05 | 0.91 | 4.52 | 1:5 | 4.52 | 0.60 | 0.91 | P | 5.0 | 10.6 | 4 | N | 87 | 86 |
| Co. 2 | 0.63 | 0.52 | 1.05 | 1.05 | 0.91 | 4.52 | 1:5 | 4.52 | 0.67 | 0.91 | P | 5.0 | 9.4 | 5 | P | 84 | 84 |
| Co. 3 | 0.44 | 0.32 | 0.75 | 0.72 | 0.70 | 3.81 | 1:5 | 3.81 | 0.42 | 0.70 | P | 5.0 | 11.3 | 3 | N | 93 | 101 |
| Ex. 4 | 0.44 | 0.32 | 0.75 | 0.85 | 0.80 | 4.38 | 1:5 | 4.38 | 0.40 | 0.80 | P | 5.0 | 10.8 | 4 | N | 92 | 87 |
| Ex. 5 | 0.44 | 0.32 | 0.75 | 1.20 | 1.25 | 4.75 | 1:5 | 4.75 | 0.41 | 1.25 | P | 5.0 | 9.9 | 4 | N | 85 | 85 |
| Co. 4 | 0.44 | 0.32 | 0.75 | 1.31 | 1.28 | 4.98 | 1:5 | 4.98 | 0.42 | 1.28 | P | 5.0 | 8.5 | 10 | N | 65 | 82 |
| Ex. 6 | 0.32 | 0.30 | 0.72 | 1.05 | 0.91 | 4.52 | 1:5 | 4.52 | 0.41 | 0.91 | N | 10.0 | 8.8 | 3 | N | 85 | 86 |
| Ex. 7 | 0.32 | 0.30 | 0.72 | 1.05 | 0.91 | 4.52 | 1:5 | 4.52 | 0.41 | 0.91 | P | 1.0 | 8.8 | 3 | N | 95 | 95 |
| Ex. 8 | 0.32 | 0.30 | 0.72 | 1.05 | 0.91 | 4.52 | 1:5 | 4.52 | 0.41 | 0.91 | P | 2.0 | 8.8 | 3 | N | 93 | 88 |
| Ex. 9 | 0.32 | 0.30 | 0.72 | 1.05 | 0.91 | 4.52 | 1:5 | 4.52 | 0.41 | 0.91 | P | 20.0 | 8.8 | 3 | N | 82 | 85 |
| Ex. 10 | 0.32 | 0.30 | 0.72 | 1.05 | 0.91 | 4.52 | 1:5 | 4.52 | 0.41 | 0.91 | P | 25.0 | 8.8 | 3 | N | 78 | 90 |
| Ex. 11 | — | — | — | — | — | — | Single | 5.00 | 0.42 | 1.02 | P | 5.0 | 8.8 | 3 | N | 87 | 87 |
| Co. 5 | — | — | — | — | — | — | Single | 6.00 | 0.44 | 1.05 | P | 5.0 | 9.5 | 15 | P | 55 | 87 |

*1: mode diameter
*2: maximum particle diameter
*3: MgO particles ratio (first MgO:second MgO)
*4: presence or absence of separator P: separator is present. N: separator is not present.
*5: thickness of heat resistant layer
*6: specific surface area in BET measurement
*7: NV change rate
*8: presence or absence of streak P: streak is present. N: streak is not present.
*9: maximum temperature

(4 A Discharge Property)

After each battery is stored under the environment at 40° C. for two days, charge and discharge are carried out by the following procedure and 4 A discharge capacity at 0° C. is determined. Firstly, at 20° C., charge is carried out at a constant current of 1.4 A until the voltage between terminals reaches 4.2 V, and charge is further carried out at a constant voltage of 4.2 V until the current is reduced to 0.1 A. Thereafter, at 0° C., discharge is carried out at a constant current of 4 A until the voltage between terminals reaches 3V.

Next, each battery is charged and discharged by the following procedure and 4 A discharge capacity at 20° C. is determined. Firstly, in the same conditions as mentioned above, each battery is charged. Thereafter, at 20° C., discharge is carried out at a constant current of 4 A until the voltage between terminals reaches 3V. Then, the ratio of 4 A discharge capacity at 0° C. to 4 A discharge capacity at 20° C. is calculated in percentage.

(Safety)

A battery, which has been evaluated as to charge and discharge capacity, is charged as follows in the environment at 20° C. Firstly, at 20° C., charge is carried out at a constant current of 1.4 A until the voltage between terminals reaches 4.25V, and charge is further carried out at a constant voltage of 4.25V until the current is reduced to 0.1 A.

At environmental temperature of 20° C., an iron wire nail having a diameter of 2.7 mm is penetrated from the side surface of the thus charged battery at the speed of 5 mm/s. Then, the end-point temperature after 90 seconds in the vicinity of the penetration portion of the battery is measured.

As shown in Table 1, in Examples 1 to 3 in which D10 is 0.2 μm or more and 0.6 μm or less, the slurry has a structural property by the interaction of the particles and a thickening property is provided. Therefore, aggregation and precipitation of aggregate are suppressed. As a result, the NV change after 7-day still standing storage is as small as 3% to 4% and no streak is observed. However, in Comparative Example 1 in which D10 is 0.16 μm, the interaction between the particles becomes excessive, thus promoting the generation of aggregation. Therefore, a large-size aggregated lump is generated and the precipitation of the slurry is activated. As a result, the NV change exceeds 10% and at the same time, the number of streaks is increased. Furthermore, in Comparative Example 2 in which D10 is 0.67 μm, since the interaction between the particles does not work, the NV change is increased and at the same time, streak is observed.

In Examples 4 and 5 in which the mode diameter is in the range from 0.8 μm to 1.25 μm, since the porosity of formed heat-resistant layer 4 is made appropriate, the discharge property and safety of the battery are achieved at a high level. However, in Comparative Example 3 in which the mode diameter is as small as 0.7 μm, since the porosity is high, the discharge property is excellent but the function of heat-resistant layer 4 is deteriorated and the maximum end-point temperature is increased in the safety test. On the contrary, in Comparative Example 4 in which the mode diameter is 1.28 μm, high safety is exhibited. However, a sufficient discharge property cannot be obtained because the porosity of heat-resistant layer 4 is low. Moreover, since the particle diameter is too large as a whole, the stability of the slurry is deteriorated.

In Comparative Example 5 in which a maximum particle diameter of the particle size distribution is 6.0 μm, the NV change is extremely large as 15%. This is thought to be because coarse grains corresponding to a maximum particle diameter are precipitated right after the slurry is produced. In addition, since the porosity of heat-resistant layer 4 is also deteriorated, the discharge property is significantly reduced.

In example 6 in which separator 7 is not used and only 10 μm-thick heat-resistant layer 4 is used, since the physical property such as a porosity of heat-resistant layer 4 is appropriate, the safety and discharge property that are equal to the case where separator 7 is used are achieved.

In Examples 1, 8 and 9 in which the thickness of heat-resistant layer 4 is 2.0 μm or more and 20 μm or less, balance of the discharge property and safety is achieved at a high level. On the other hand, in Example 7 in which the thickness is 1.0 μm, the safety is somewhat deteriorated. In Example 10 in which the thickness is 25 μm, the discharge property is somewhat deteriorated.

In the Examples mentioned above, heat-resistant layer 4 using a mixture including two kinds of magnesium oxides is mainly described. In addition to this, even in Example 11 in which a single magnesium oxide is used, if the condition of the particle size distribution is satisfied, the coating property of slurry or the safety and the discharge property can be maintained at a high level.

### INDUSTRIAL APPLICABILITY

A lithium ion secondary battery of the present invention can achieve an excellent balance of the safety and the discharge property at a high level. Therefore, the battery is useful as a power supply for electric bicycles, electric vehicles, electric tools, and the like.

1. A lithium ion secondary battery, comprising:
a positive electrode reversibly absorbing and releasing lithium ions;
a negative electrode reversibly absorbing and releasing lithium ions at a lower potential than the positive electrode;
a porous heat-resistant layer provided between the positive electrode and the negative electrode; and
a nonaqueous electrolyte impregnated into the porous heat-resistant layer and existing between the positive electrode and the negative electrode,
wherein the porous heat-resistant layer includes a metal oxide as filler having a distribution of a particle diameter of 0.1 μm or more and 5.0 μm or less, D10 in particle size distribution measurement of 0.2 μm or more and 0.6 μm or less, and a mode diameter of 0.80 μm or more and 1.25 μm or less.

2. The lithium ion secondary battery according to claim 1, further comprising a separator made of a microporous film and interposed between the positive electrode and the negative electrode.

3. The lithium ion secondary battery according to claim 2, wherein a thickness of the porous heat-resistant layer is 2 μm or more and 20 μm or less.

4. The lithium ion secondary battery according to claim 1, wherein the filler is magnesium oxide.

5. The lithium ion secondary battery according to claim 1, wherein a specific surface area in BET measurement of the filler is 5 m²/g or more and 12 m²/g or less.
